(19) United States
(12) Patent Application Publication
(10) Pub. No.: US 2004/0225045 A1
(43) Pub. Date: Nov. 11, 2004

(54) Highly conductive resin compositions

(75) Inventor: Deborah Derfelt Forray, San Diego, CA (US)

Correspondence Address: HENKEL LOCTITE CORPORATION, Legal Department, 1001 Trout Brook Crossing, Rocky Hill, CT, 06067, US

(73) Assignee: HENKEL LOCTITE CORPORATION

(21) Appl. No.: 10/429,039

(22) Filed: May 5, 2003

(51) Int. Cl. C08K 5/24

(52) U.S. Cl. 524/262; 524/548; 524/555; 524/612; 524/439; 524/431

(57) ABSTRACT

The present invention relates to resin compositions, particularly those having a high degree of conductivity. In particular, the present invention relates to highly conductive die attach compositions useful for attaching semiconductor devices to carrier substrates. The invention further provides methods of preparing such compositions, methods of applying such compositions to substrate surfaces, and packages and assemblies prepared therewith for connecting microelectronic circuitry.

### BACKGROUND OF THE INVENTION

1. Field of the Invention

The present invention relates to resin compositions, particularly those having a high degree of conductivity. In particular, the present invention relates to highly conductive die attach compositions useful for attaching semiconductor devices to carrier substrates. The invention further provides methods of preparing such compositions, methods of applying such compositions to substrate surfaces, and packages and assemblies prepared therewith for connecting microelectronic circuitry.

2. Brief Description of Related Technology

Thermosetting resins are commonly used in adhesive formulations due to the outstanding performance properties which can be achieved by forming a fully crosslinked (i.e., thermoset), three-dimensional network. These properties include cohesive bond strength, resistance to thermal and oxidative damage, and low moisture uptake. As a result, common thermosetting resins such as epoxy resins, bismaleimide resins, and cyanate ester resins have been employed extensively in applications ranging from structural adhesives (e.g., construction and aerospace applications) to microelectronics (e.g., die-attach and underfill applications).

Bismaleimides occupy a prominent position in the spectrum of thermosetting resins, and a number of bismaleimides are commercially available. Bismaleimides have been used for the production of moldings and adhesive joints, heat-resistant composite materials, and high temperature coatings. More recently, Henkel Loctite Corporation has commercialized a number of products based in part on certain bismaleimides for the attachment of semiconductor chips to circuit boards, which have received favorable responses from within the microelectronic industry. These products are covered in one or more of U.S. Pat. No. 5,789,757 (Husson), U.S. Pat. No. 6,034,194 (Dershem), U.S. Pat. No. 6,034,195 (Dershem) and U.S. Pat. No. 6,187,886 (Husson).

In certain instances, it is desirable to render such thermosetting resin compositions conductive, either thermally or electrically. This is typically achieved by the addition of a conductive filler, oftentimes a metallic filler, such as silver, in particle and/or flake form. While generally the addition of the conductive filler provides adequate conductivity to the composition, in certain instances greater conductivity is desirable. Such instances include those where an microelectronic assembler desires to validate its process prior to attaching the multitude of wire bonds from the semiconductor chip to the circuit board, and thus tests for electrical conductivity at the point where the chip is attached to the board. Other instances include those where the microelectronic assembler seeks to achieve a higher degree of thermal conductivity for thermal management or heat dissipation reasons.

In these cases, conventional wisdom leads one to either increase the loading level of conductive filler, select a more conductive filler, or choose a combination of fillers or particle sizes of fillers (such as is described in U.S. Pat. No. 6,375,730). While choosing a more conductive filler or a combination of fillers or particle sizes of fillers may be satisfactory for certain applications, it would be desirable to simply maintain the selected conductive filler, and perhaps increase its loading level. However, increasing the loading level of the conductive filler may affect adversely the rheology of the composition, thereby causing dispensing and/or flow issues. Oftentimes, increasing the loading level of the conductive filler may even adversely affect the conductivity itself.

In unrelated technology, U.S. Pat. No. 5,298,562 reports the use of magnesium methacrylate to cure cis-1,4-polybutadiene elastomers is described in “Elastic Properties and Structures of Polybutadiene Vulcanized with Magnesium Methacrylate”, J. Appl. Polym. Sci., 16, 505-518 (1972). The '562 patent also reports that A. A. Dontsov, “General Regularities of Heterogeneous Vulcanization”, Rubbercon '77, International Rubber Conference, 2, 26-1 through 26-12 (1977) describes vulcanizable compositions of styrene-butadiene rubber or ethylene-propylene rubber cured with a magnesium, sodium, zinc or cadmium salt of methacrylic, maleic or betaphenyl acrylic acids, together with free radical initiators such as dicumyl peroxide.

In addition, the '562 patent itself speaks to the use of calcium acrylate and methacrylate as cross-linking agents, and spells out as an objective the provision of an improved free radical curable composition having good chemical and heat resistance. This objective is achieved by a composition that contains a halogenated polyethylene polymer crosslinked with a calcium di(meth)acrylate crosslinking agent, and is reported to improve tensile strength and scorch resistance over other prior art compositions employing different crosslinking coagents. The '562 patent also speaks to new and improved processes for the preparation of free radical curable calcium di(meth)acrylate crosslinked halogenated polyethylene copolymers.

And U.S. Pat. No. 5,776,294 describes the use of metal salts of certain α,β-ethylenically unsaturated carboxylic acids, specifically the metal salts of acrylic and methacrylic acids, as crosslinking coagents, to yield cured elastomer compositions with improved adhesive properties with respect to polar surfaces. The adhesive properties reported include lap shear adhesion to cold rolled steel, stainless steel, brass, zinc, aluminum, and nylon fiber. Examples of the metal component for those metal salts of acrylic and methacrylic acids are reported as zinc, magnesium, sodium, potassium, calcium, barium, cobalt, copper, aluminum and iron. See also U.S. Pat. No. 6,194,504, which claims a composition comprising MAₙ salt in particulate form having improved dispersibility in elastomers, where M is a zinc, calcium, magnesium, potassium, sodium, lithium, iron, zirconium, aluminum, barium and bismuth; A is acrylate or methacrylate; and n is 1-4; where the salt encapsulated with a polymer selected from polybutadiene, hydroxy-terminated polybutadiene, polybutadiene dimethacrylate, ethylene-butylene diacrylate, natural rubber, polybutene, and EPDM; and where the polymer encapsulates the salt upon drying a polymeric solution of the salt, the polymer and an organic solvent.

Notwithstanding the state-of-the-technology, it would be desirable to be able to confer a higher level of conductivity to a thermosetting resin composition, without having to adjust the identity or the loading of the conductive filler itself.

Until now, this is not believed to have been reported or observed in a free radically polymerizable composition.

### SUMMARY OF THE INVENTION

The present invention is directed to highly conductive curable compositions. These compositions include (a) a free radical polymerizable component; (b) an organometallic complex; (c) a conductive filler; and (d) a cure initiator. The cured products of the composition are capable of demonstrating about a two fold increase in conductivity over compositions of component (a), (c) and (d) without component (b). The free radical polymerizable component in a desirable aspect of the invention may be selected from one or more of a maleimide-containing compound, itaconimide-containing compound, or a nadimide-containing compound. Desirably, the free radical polymerizable component is curable by way of exposure to elevated temperature conditions, though it may alternatively be cured by exposure to radiation in the electromagnetic spectrum, as more fully set forth below.

The present invention also provides a method of making the inventive compositions, a method of adhesively attaching one substrate, such as a semiconductor chip, to another substrate, such as a another semiconductor chip, a carrier substrate or a circuit board, a method of improving the conductivity of a conductive, curable composition.

The present invention furthder provides cured reaction products of the inventive conuductive, curable compositions.

The present invention also provides an article of manufacture, and in particular, a semiconductor chip which is attached to and in electrical interconnection with another semiconductor chip, a carrier substrate or a circuit board. That is, the invention provides an article of manufacture comprising a semiconductor chip attached to and in electrical interconnection with either another semiconductor chip, a carrier substrate or a circuit board, the semiconductor chip having a first surface and a second surface, with the first surface having electrical contacts arranged in a predetermined pattern thereon for providing electrical engagement with the another semiconductor chip, the carrier substrate, or the circuit board, respectively, and with the second surface having a cured inventive composition disposed on a layer or a portion thereof, so as to provide attachment between the semiconductor chip and the another semiconductor chip, the carrier substrate, or the circuit board, respectively.

### DETAILED DESCRIPTION OF THE INVENTION

As noted above, the present invention is directed to highly conductive curable compositions, which include (a) a free radical polymerizable component; (b) an organometallic complex; (c) a conductive filler; and (d) a cure initiator. The cured products of the composition are capable of demonstrating about two fold increase in conductivity over compositions of component (a), (c) and (d) without component (b).

As a free radically polymerizable component, a variety of different classes of compounds are available. For instance, maleimides, itaconimides, nadimides, (meth)acrylates, fumarates, maleates, vinyl ethers, vinyl esters, styrene and derivatives thereof, poly(alkenylene)s, allyl amides, norbornenyls, thiolenes, acrylonitriles and combinations thereof may be used.

Maleimides, nadimides, and itaconimides contemplated for use in the practice of the present invention include compounds having, respectively, the following structures I, II, and III:

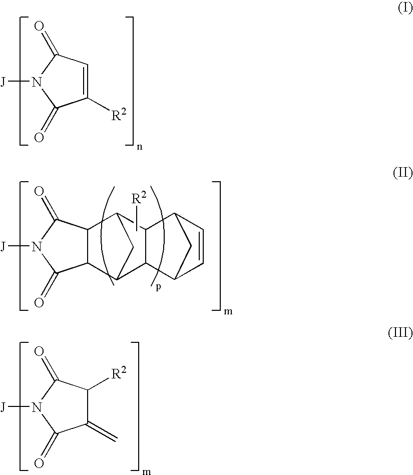

where:

m=1-15,

p=0-15,

each R² is independently selected from hydrogen or lower alkyl, and

J is a monovalent or a polyvalent moiety comprising organic or organosiloxane radicals, and combinations of two or more thereof.

More specific representations of the maleimides, itaconimides and nadimides include those corresponding to structures I, II and III, where

m=1-6,

p=0,

each R² is independently selected from hydrogen or lower alkyl, and

J is a monovalent or polyvalent radical selected from hydrocarbyl, substituted hydrocarbyl, heteroatom-containing hydrocarbyl, substituted heteroatom-containing hydrocarbyl, hydrocarbylene, substituted hydrocarbylene, heteroatom-containing hydrocarbylene, substituted heteroatom-containing hydrocarbylene, polysiloxane, polysiloxane-polyurethane block copolymer, and combinations of two or more thereof, optionally containing one or more linkers selected from a covalent bond, —O—, —S—, —NR—, —O—C(O)—, —O—C(O)—O—, —O—C(O)—NR—, —NR—C(O)—, —NR—C(O)—O—, —NR—C(O)—NR—, —S—C(O)—, —S—C(O)—O—, —S—C(O)—NR—, —S(O)—, —S(O)₂—, —O—S(O)₂—, —O—S(O)₂—O—, —O—S(O)₂—NR—, —O—S(O)—, —O—S(O)—O—, —O—S(O)—NR—, —O—NR—C(O)—, —O—NR—C(O)—O—, —O—NR—C(O)—NR—, —NR—O—C(O)—, —NR—O—C(O)—O—, —NR—O—C(O)—NR—, —O—NR—C(S)—, —O—NR—C(S)—O—, —O—NR—C(S)—NR—, —NR—O—C(S)—, —NR—O—C(S)—O—, —NR—O—C(S)—NR—, —O—C(S)—, —O—C(S)—O—, —O—C(S)—NR—, —NR—C(S)—, —NR—C(S)—O—, —NR—C(S)—NR—, —S—S(O)₂—, —S—S(O)₂—O—, —S—S(O)₂—NR—, —NR—O—S(O)—, —NR—O—S(O)—O—, —NR—O—S(O)—NR—, —NR—O—S(O)₂—, —NR—O—S(O)₂—O—, —NR—O—S(O)₂—NR—, —O—NR—S(O)—, —O—NR—S(O)—O—, —O—NR—S(O)—NR—, —O—NR—S(O)₂—, —O—NR—S(O)₂—NR—, —O—NR—S(O)₂—, —O—P(O)R₂—, —S—P(O)R₂—, —NR—P(O)R₂—, where each R is independently hydrogen, alkyl or substituted alkyl, and combinations of any two or more thereof.

When one or more of the above described monovalent or polyvalent groups contain one or more of the above described linkers to form the “J” appendage of a maleimide, nadimide or itaconimide group, as readily recognized by those of skill in the art, a wide variety of linkers can be produced, such as, for example, oxyalkyl, thioalkyl, aminoalkyl, carboxylalkyl, oxyalkenyl, thioalkenyl, aminoalkenyl, carboxyalkenyl, oxyalkynyl, thioalkynyl, aminoalkynyl, carboxyalkynyl, oxycycloalkyl, thiocycloalkyl, aminocycloalkyl, carboxycycloalkyl, oxycloalkenyl, thiocycloalkenyl, aminocycloalkenyl, carboxycycloalkenyl, heterocyclic, oxyheterocyclic, thioheterocyclic, aminoheterocyclic, carboxyheterocyclic, oxyaryl, thioaryl, aminoaryl, carboxyaryl, heteroaryl, oxyheteroaryl, thioheteroaryl, aminoheteroaryl, carboxyheteroaryl, oxyalkylaryl, thioalkylaryl, aminoalkylaryl, carboxyalkylaryl, oxyarylalkyl, thioarylalkyl, aminoarylalkyl, carboxyarylalkyl, oxyarylalkenyl, thioarylalkenyl, aminoarylalkenyl, carboxyarylalkenyl, oxyalkenylaryl, thioalkenylaryl, aminoalkenylaryl, carboxyalkenylaryl, oxyarylalkynyl, thioarylalkynyl, aminoarylalkynyl, carboxyarylalkynyl, oxyalkynylaryl, thioalkynylaryl, aminoalkynylaryl or carboxyalkynylaryl, oxyalkylene, thioalkylene, aminoalkylene, carboxyalkylene, oxyalkenylene, thioalkenylene, aminoalkenylene, carboxyalkenylene, oxyalkynylene, thioalkynylene, aminoalkynylene, carboxyalkynylene, oxycycloalkylene, thiocycloalkylene, aminocycloalkylene, carboxycycloalkylene, oxycycloalkenylene, thiocycloalkenylene, aminocycloalkenylene, carboxycycloalkenylene, oxyarylene, thioarylene, aminoarylene, carboxyarylene, oxyalkylarylene, thioalkylarylene, aminoalkylarylene, carboxyalkylarylene, oxyarylalkylene, thioarylalkylene, aminoarylalkylene, carboxyarylalkylene, oxyarylalkenylene, thioarylalkenylene, aminoarylalkenylene, carboxyarylalkenylene, oxyalkenylarylene, thioalkenylarylene, aminoalkenylarylene, carboxyalkenylarylene, oxyarylalkynylene, thioarylalkynylene, aminoarylalkynylene, carboxy arylalkynylene, oxyalkynylarylene, thioalkynylarylene, aminoalkynylarylene, carboxyalkynylarylene, heteroarylene, oxyheteroarylene, thioheteroarylene, aminoheteroarylene, carboxyheteroarylene, heteroatom-containing di- or polyvalent cyclic moiety, oxyheteroatom-containing di- or polyvalent cyclic moiety, thioheteroatom-containing di- or polyvalent cyclic moiety, aminoheteroatom-containing di- or polyvalent cyclic moiety, carboxyheteroatom-containing di- or polyvalent cyclic moiety, disulfide, sulfonamide, and the like.

In another embodiment, maleimides, nadimides, and itaconimides contemplated for use in the practice of the present invention have the structures I, II, or III, where m=1-6, p=0-6, and J is selected from saturated straight chain alkyl or branched chain alkyl, optionally containing optionally substituted aryl moieties as substituents on the alkyl chain or as part of the backbone of the alkyl chain, and where the alkyl chains have up to about 20 carbon atoms;

a siloxane having the structure: —(C(R³)₂)_{d}—[Si(R⁴)₂—O]_{f}—Si(R⁴)₂—(C(R³)₂)ₑ—, —(C(R³)₂)_{d}—C(R³)—C(O)O—(C(R³)₂)_{d}—[Si(R⁴)₂—O]_{f}—Si(R⁴)₂—(C(R³)₂)ₑ—O(O)C—(C(R³)₂)ₑ—, or —(C(R³)₂)_{d}—C(R³)—O(O)C—(C(R³)₂)_{d}—[Si(R⁴)₂—O]_{f}—Si(R⁴)₂—(C(R³)₂)ₑ—C(O)O—(C(R³)₂)ₑ—, where:

each R³ is independently hydrogen, alkyl or substituted alkyl,

each R⁴ is independently hydrogen, lower alkyl or aryl,

d=1-10,

e=1-10, and

f=1-50;

a polyalkylene oxide having the structure:

[(CR₂)ᵣ—O—]_{f}—(CR₂)ₛ—

where:

each R here is independently hydrogen, lower alkyl or substituted alkyl,

r=1-10,

s=1-10, and

f is as defined above;

aromatic groups having the structure:

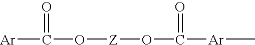

where:

each Ar is a monosubstituted, disubstituted or trisubstituted aromatic or heteroaromatic ring having in the range of 3 up to 10 carbon atoms, and

Z is:

saturated straight chain alkylene or branched chain alkylene, optionally containing saturated cyclic moieties as substituents on the alkylene chain or as part of the backbone of the alkylene chain, or

polyalkylene oxides having the structure:

—[(CR₂)ᵣ—O—]_{q}—(CR₂)ₛ—

where:

each R is independently selected from hydrogen or lower alkyl, r and s are each defined as above, and

q falls in the range of 1 up to 50;

di- or tri-substituted aromatic moieties having the structure:

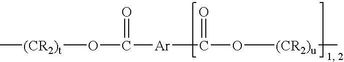

where:

each R is independently selected from hydrogen or lower alkyl,

t falls in the range of 2 up to 10,

u falls in the range of 2 up to 10, and

Ar is as defined above;

aromatic groups having the structure:

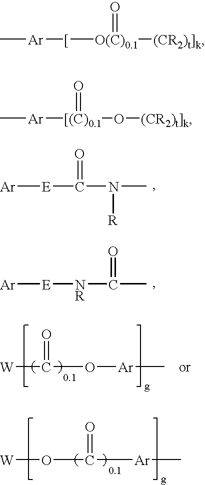

where:

each R is independently selected from hydrogen or lower alkyl,

t=2-10,

k=1, 2 or 3,

g=1 up to about 50,

each Ar is as defined above,

E is —O— or —NR⁵—, where R⁵ is hydrogen or lower alkyl; and

W is straight or branched chain alkyl, alkylene, oxyalkylene, alkenyl, alkenylene, oxyalkenylene, ester, or polyester, a siloxane having the structure —(C(R³)₂)_{d}—[Si(R⁴)₂—O]_{f}—Si(R⁴)₂—(C(R³)₂)ₑ—, —(C(R³)₂)_{d}—C(R³)—C(O)O—(C(R³)₂)_{d}—[Si(R⁴)₂—O]_{f}—Si(R⁴)₂—(C(R³)₂)ₑ—O(O)C—(C(R³)₂)ₑ—, or —(C(R³)₂)_{d}—C(R³)—O(O)C—(C(R³)₂)_{d}—[Si(R⁴)₂—O]_{f}—Si(R⁴)₂—(C(R³)₂)ₑ—C(O)O—(C(R³)₂)ₑ—, where:

each R³ is independently hydrogen, alkyl or substituted alkyl,

each R⁴ is independently hydrogen, lower alkyl or aryl,

d=1-10,

e=1-10, and

f=1-50; or

a polyalkylene oxide having the structure:

—[(CR₂)ᵣ—O—]_{f}—(CR₂)ₛ—

where:

each R is independently hydrogen, alkyl or substituted alkyl,

r=1-10,

s=1-10, and

f is as defined above;

optionally containing substituents selected from hydroxy, alkoxy, carboxy, nitrile, cycloalkyl or cycloalkenyl;

a urethane group having the structure:

R⁷—U—C(O)—NR⁶—R⁸—NR⁶—C(O)—(O—R⁸—O—C(O)—NR⁶—R⁸—NR⁶—C(O))ᵥ—U—R⁸—

where:

each R⁶ is independently hydrogen or lower alkyl,

each R⁷ is independently an alkyl, aryl, or arylalkyl group having 1 to 18 carbon atoms,

each R⁸ is an alkyl or alkyloxy chain having up to about 100 atoms in the chain, optionally substituted with Ar,

U is —O—, —S—, —N(R)—, or —P(L)_{1,2}-,

where R as defined above, and where each L is independently ═O, ═S, —OR or —R; and

v=0-50;

polycyclic alkenyl; or

mixtures of any two or more thereof.

In a particularly desirable aspect of the invention, the maleimide, itaconimide and/or nadimide functional group of the maleimide, itaconimide and/or nadimide compound, respectively, is attached to J, a monovalent radical, or the maleimide, itaconimide and/or nadimide functional groups of the maleimide, itaconimide and/or nadimide compound are separated by J, a polyvalent radical, each of the monovalent radical or the polyvalent radical having sufficient length and branching to render the maleimide, itaconimide and/or nadimide compound a liquid.

In a more specific aspect thereof, J comprises a branched chain alkyl, alkylene or alkylene oxide species having sufficient length and branching to render the maleimide, itaconimide or nadimide compound a liquid, each R² is independently selected from hydrogen or methyl and m is 1, 2 or 3.

The (meth)acrylates may be chosen from a host of different compounds. As used herein, the terms (meth)acrylic and (meth)acrylate are used synonymously with regard to the monomer and monomer-containing component. The terms (meth)acrylic and (meth)acrylate include acrylic, methacrylic, acrylate and methacrylate.

The (meth)acrylate component may comprise one or more members selected from a monomer represented by the formula:

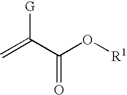

where G is hydrogen, halogen, or an alkyl having from 1 to 4 carbon atoms, R¹ here has from 1 to 16 carbon atoms and is an alkyl, cycloalkyl, alkenyl, cycloalkenyl, alkaryl, aralkyl, or aryl group, optionally substituted or interrupted with silane, silicon, oxygen, halogen, carbonyl, hydroxyl, ester, carboxylic acid, urea, urethane, carbamate, amine, amide, sulfur, sulfonate, or sulfone;

urethane acrylates or ureide acrylates represented by the formula:

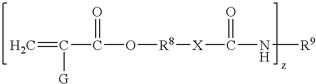

where

G is hydrogen, halogen, or an alkyl having from 1 to 4 carbon atoms;

R⁸ here denotes a divalent aliphatic, cycloaliphatic, aromatic, or araliphatic group, bound through a carbon atom or carbon atoms thereof indicated at the —O— atom and —X— atom or group;

X is —O—, —NH—, or —N(alkyl)-, in which the alkyl radical has from 1 to 8 carbon atoms;

z is 2 to 6; and

R⁹ here is a z-valent cycloaliphatic, aromatic, or araliphatic group bound through a carbon atom or carbon atoms thereof to the one or more NH groups; and

a di- or tri-(meth)acrylate selected from polyalkylene glycol di(meth)acrylates, bisphenol-A di(meth)acrylates, bisphenol-F di(meth)acrylates, bisphenol-S di(meth)acrylates, tetrahydrofurane di(meth)acrylates, hexanediol di(meth)acrylate, trimethylol propane tri(meth)acrylate, or combinations thereof.

Suitable polymerizable (meth)acrylate monomers include diethylene glycol di(meth)acrylate, triethylene glycol di(meth)acrylate, tetraethylene glycol di(meth)acrylate, dipropylene glycol di(meth)acrylate, tripropylene glycol di(meth)acrylate, tertrapropylene glycol di(meth)acrylate, 1,4-butanediol di(meth)acrylate, 1,6-hexanediol di(meth)acrylate, pentaerythritol tetra(meth)acrylate, trimethylol propane tri(meth)acrylate, di-pentaerythritol monohydroxypenta(meth)acrylate, pentaerythritol tri(meth)acrylate, bisphenol-A-ethoxylate di(meth)acrylate, trimethylolpropane ethoxylate tri(meth)acrylate, trimethylolpropane propoxylate tri(meth)acrylate, and bisphenol-A-diepoxide dimethacrylate.

Additionally, the (meth)acrylate monomers include tetrahydrofurane (meth)acrylates and di(meth)acrylates, citronellyl(meth)acrylate, hydroxypropyl(meth)acrylate, tetrahydrodicyclopentadienyl(meth)acrylate, triethylene glycol (meth)acrylate, triethylene glycol (meth)acrylate, and combinations thereof.

Of course, (meth)acrylated silicones may also be used, provided the silicone backbone is not so large so as to minimize the effect of (meth)acrylate when cure occurs.

Other acrylates suitable for use herein include the low viscosity acrylates disclosed and claimed in U.S. Pat. No. 6,211,320 (Dershem), the disclosure of which is expressly incorporated herein by reference.

The fumarates include those comprising the following general structure:

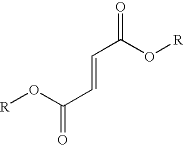

and the maleates include those comprising the following general structure:

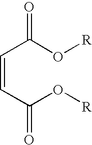

where R for each of the fumarates and maleates may be selected from R¹ as defined above.

The vinyl ethers and vinyl esters include those comprising the following general structure:

Y—[-Q_{0.1}—CR═CH₂R]_{q}

where:

q is 1, 2 or 3,

each R here is independently selected from hydrogen or lower alkyl, each Q is independently selected from —O—, —O—C(O)—, —C(O)— or —C(O)—O—, and

Y is defined as J with respect to structures I, II and III above.

Examples of vinyl ethers or vinyl esters embraced by the above generic structure include stearyl vinyl ether, behenyl vinyl ether, eicosyl vinyl ether, isoeicosyl vinyl ether, isotetracosyl vinyl ether, poly(tetrahydrofuran) divinyl ether, tetraethylene glycol divinyl ether, tris-2,4,6-(1-vinyloxybutane-4-oxy-1,3,5-triazine, bis-1,3-(1-vinyloxybutane-4-)oxycarbonyl-benzene (alternately referred to as bis(4-vinyloxybutyl)isophthalate; available from Allied-Signal Inc., Morristown, N.J., under the trade name VECTOMER 4010), divinyl ethers prepared by transvinylation between lower vinyl ethers and higher molecular weight di-alcohols.

Particularly desirable divinyl resins include stearyl vinyl ether, behenyl vinyl ether, eicosyl vinyl ether, isoeicosyl vinyl ether, poly(tetrahydrofuran) divinyl ether, divinyl ethers prepared by transvinylation between lower vinyl ethers and higher molecular weight di-alcohols.

Styrene and its derivatives include those comprising the following general structure:

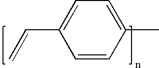

where n is 1-6, attached to J as defined above.

As the allyl amide, a variety of compounds may be chosen, such as those satisfying the criteria set forth above with respect to the maleimides, itaconimides and/or nadimides.

For instance, in a more specific representation, those corresponding to the following structure:

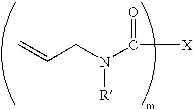

where

R′ is hydrogen, C₁ to about C₁₈ alkyl or oxyalkyl, allyl, aryl, or substituted aryl,

m is 1-6, and

X is as defined above for J.

The norbornenyl component include those comprising the following general structure:

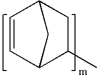

where m is 1-6, attached to J as defined above.

The thiolene component include those comprising the following general structure:

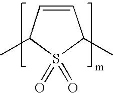

where m is 1-6, attached to J as defined above.

The free radically polymerizable component may be in the solid state at room temperature or in the liquid state at room temperature. When in the solid state, they may be used alone and blended into the composition at room temperature or under mildly elevated conditions. Alternatively, the free radically polymerizable component in the solid state may be dissolved in another component or additive of the inventive compositions, in a liquid free radically polymerizable component, or in a reactive or, though not preferred, a non-reactive diluent.

Certain maleimide-containing compounds useful in the practice of the present invention include, for example, maleimides having the following structures:

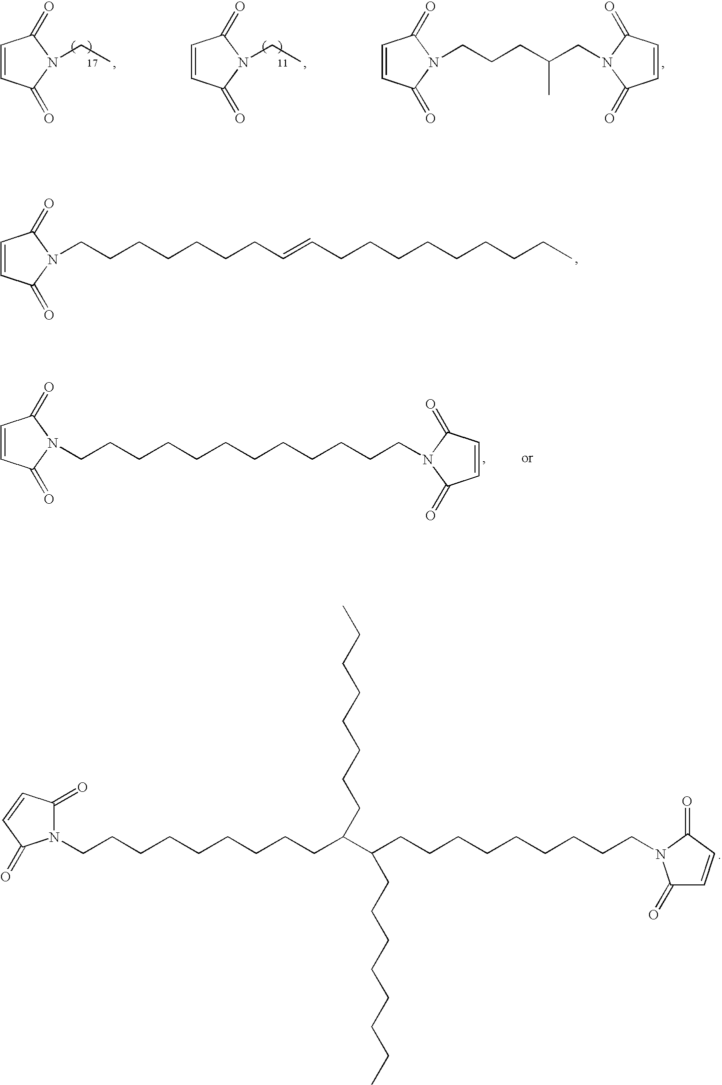

Additional maleimide-containing compounds of formula I include stearyl maleimide, oleyl maleimide and behenyl maleimide, 1,20-bismaleimido-10,11-dioctyl-eicosane, and the like, as well as combinations thereof.

Particularly desirable maleimide compounds embraced by formula I include bismaleimides prepared by reaction of maleic anhydride with dimer amides. An exemplary bismaleimide which can be prepared from such dimer amides is 1,20-bismaleimido-10,11-dioctyl-eicosane, which would likely exist in admixture with other isomeric species produced in the ene reactions employed to produce dimer acids. Other bismaleimides contemplated for use in the practice of the present invention include bismaleimides prepared from aminopropyl-terminated polydimethyl siloxanes (such as “PS510” sold by Hüls America, Piscataway, N.J.), polyoxypropylene amines (such as “D-230”, “D-400”, “D-2000” and “T-403”, sold by Texaco Chemical Company, Houston, Tex.), polytetramethyleneoxide-di-p-aminobenzoates (such as the family of such products sold by Air Products, Allentown, Pa., under the trade name “VERSALINK”, e.g., “VERSALINK” P-650), and the like. Preferred maleimide resins of formula I include stearyl maleimide, oleyl maleimide, behenyl maleimide, 1,20-bismaleimido-10,11-dioctyl-eicosane, and the like, as well as mixtures of any two or more thereof.

Bismaleimides can be prepared employing techniques well known to those of skill in the art, and as such will not be repeated here.

The free radical polymerizable component should be present in an amount of about 2 wt % to about 40 wt %, desirable about 5 wt % to about 10 wt %, based on the total composition.

The organometallic complex used in the inventive compositions may be chosen from (meth)acrylated metal complexes, such as (meth)acrylate metal complexes of zinc, magnesium, sodium, potassium, calcium, barium, cobalt, copper, aluminum, iron and combinations thereof, with calcium (meth)acrylate complexes and zinc (meth)acrylate complexes, each of which being commercially available from Sartomer, Inc., Exton, Pa. under the SARET tradename, with SARET 633 and 634, being particularly desirable.

The organometallic complex should be present in an amount of about 0.05 wt % to about 2.5 wt %, such as about 0.1 wt % to about 1 wt %, desirable about 0.5 wt %, based on the tptal composition.

As a conductive filler, the inventive compositions may include electrically and/or thermally ones. These conductive fillers include, for example, silver, nickel, gold, cobalt, copper, aluminum, graphite, silver-coated graphite, nickel-coated graphite, alloys of such metals, and the like, as well as mixtures thereof. Both powder and flake forms of filler may be used in the inventive compositions. Preferably, the flake has a thickness of less than about 2 microns, with planar dimensions of about 20 to about 25 microns. Flake employed herein preferably has a surface area of about 0.15 to 5.0 m²/g and a tap density of about 0.4 up to about 5.5 g/cc. It is presently preferred that powder employed in the practice of the invention has a diameter of about 0.5 to 15 microns.

Other conductive fillers oftentimes used to confer thermal conductivity include, for example, aluminum nitride, boron nitride, silicon carbide, diamond, graphite, beryllium oxide, magnesia, silica, alumina, and the like. Preferably, the particle size of these fillers will be in the range of about 5 up to about 30 microns. Most preferably, the particle size of these fillers will be about 20 microns.

Electrically and/or thermally conductive fillers may be optionally rendered substantially free of catalytically active metal ions by treatment with chelating agents, reducing agents, nonionic lubricating agents, or mixtures of such agents. Such treatment is described in U.S. Pat. No. 5,447,988, which is incorporated by reference herein in its entirety.

The conductive filler typically comprises in the range of about 1 wt % up to about 95 wt %, such as about 50 wt % up to about 85 wt %, desirably about 70 to about 80 wt %, of the total composition.

The cure initiator may be a radical heat cure catalyst or a radical photocure catalyst (also called, a photoinitiator). The cure initiator refers to any chemical species which, upon exposure to sufficient energy (e.g., light, heat, or the like), decomposes into at least two species which are uncharged, but which each possesses at least one unpaired electron. Desirable cure initiators for use herein are compounds which decompose (i.e., have a half life in the range of about 10 hours) at temperatures in the range of about 70 up to 200° C. In practice, conditions suitable to cure the inventive compositions thus include an elevated temperature of less than 200° C. for about 0.25 up to 2 minutes.

The cure initiator should be present in an amount of about 0.1 to about 5 wt %, such as about 0.5 to about 2 wt %, based on the toatl composition.

Radical heat cure initiators contemplated for use in the practice of the present invention include, for example, peroxides (e.g., peroxy esters, peroxy carbonates, hydroperoxides, alkylperoxides, arylperoxides, and the like), azo compounds, and the like. Presently preferred peroxides contemplated for use in the practice of the present invention include dicumyl peroxide, dibenzoyl peroxide, 2-butanone peroxide, tert-butyl perbenzoate, di-tert-butyl peroxide, 2,5-bis(tert-butylperoxy)-2,5-dimethylhexane, bis(tert-butyl peroxyisopropyl)benzene, tert-butyl hydroperoxide, and the like. Presently preferred azo compounds contemplated for use in the practice of the present invention include 2,2′-azobis(2-methylpropanenitrile), 2,2′-azobis(2-methylbutanenitrile), 1,1′-azobis(cyclohexanecarbonitrile), and the like.

Radiation free-radical cure initiators (or, photoinitiators) include for example, those commercially available from Vantico Inc., Brewster, N.Y. under the tradename “IRGACURE” and “DAROCUR”, such as “IRGACURE” 184 (1-hydroxycyclohexyl phenyl ketone), 907 (2-methyl-1-[4-(methylthio)phenyl]-2-morpholino propan-1-one), 369 [2-benzyl-2-N,N-dimethylamino-1-(4-morpholinophenyl)-1-butanone], 500 (the combination of 1-hydroxy cyclohexyl phenyl ketone and benzophenone), 651 (2,2-dimethoxy-2-phenyl acetophenone), 1700 [the combination of bis(2,6-dimethoxybenzoyl-2,4,4-trimethyl pentyl) phosphine oxide and 2-hydroxy-2-methyl-1-phenyl-propan-1-one] and “DAROCUR” 1173 (2-hydroxy-2-methyl-1-phenyl-1-propane) and 4265 (the combination of 2,4,6-trimethylbenzoyldiphenyl-phosphine oxide and 2-hydroxy 2-methyl-1-phenyl-propan-1-one); photoinitiators available commercially from Union Carbide Chemicals and Plastics Co., Inc., Danbury, Conn. under the “CYRACURE” tradename, such as “CYRACURE”. UVI-6974 (mixed triaryl sulfonium hexafluoroantimonate salts) and UVI-6990 (mixed triaryl sulfonium hexafluorophosphate salts); and the visible light [blue] photoinitiators, dl-camphorquinone and “IRGACURE” 784DC.

Additional photoinitiators may be chosen from those available from Sartomer, Inc., Exton, Pa. under the tradenames “ESACURE” and “SARCAT”. Examples include “ESACURE” KB1 (benzil dimethyl ketal), “ESACURE” EB3 (mixture of benzoin and butyl ethers), “ESACURE” TZT (trimethylbenzophenone blend), “ESACURE” KIP100F (hydroxy ketone), “ESACURE” KIP150 (polymeric hydroxy ketone), “ESACURE” KT37 (blend of “ESACURE” TZT and KIP150), “ESACURE” KT046 (blend of triphenyl phosphine oxide, “ESACURE” KIP150 and TZT), “ESACURE” X33 (blend of 2- and 4-isopropylthioxanthone, ethyl 4-(dimethyl amino)benzoate and “ESACURE” TZT], “SARCAT” CD 1010 [triaryl sulfonium hexafluoroantimonate (50% in propylene carbonate)], “SARCAT” DC 1011 [triaryl sulfonium hexafluorophosphate (50% n-propylene carbonate)], “SARCAT” DC 1012 (diaryl iodonium hexafluoroantimonate), and “SARCAT” K185 [triaryl sulfonium hexafluorophosphate (50% in propylene carbonate)].

Photoinitiators include triarylsulfonium and diaryliodonium salts containing non-nucleophilic counterions and aryl diazonium salts, examples of which include 4-methoxybenzenediazonium hexafluorophosphate, benzenediazonium tetrafluoroborate, diphenyl iodonium chloride, diphenyl iodonium hexafluorophosphate, 4,4-dioctyloxydiphenyl iodonium hexafluorophosphate, triphenylsulfonium tetrafluoroborate, diphenyltolylsulfonium hexafluorophosphate, phenylditolylsulfonium hexafluoroarsenate, and diphenyl-thiophenoxyphenylsulfonium hexafluoroantimonate.

Of course, combinations of such photoinitiators may be used as deemed appropriate by those of ordinary skill in the art.

The composition may be substantially free of non-reactive diluent, depending on the constituents used. However, it may be desirable to use a non-reactive diluent during the formulation of the inventive compositions.

When a diluent is added, it is ordinarily desirable for the diluent to be a reactive diluent which, in combination with the maleimide-containing compound, forms a resin composition. Such reactive diluents include acrylates and methacrylates of monofunctional and polyfunctional alcohols, vinyl compounds as described in greater detail herein, styrenic monomers (i.e., ethers derived from the reaction of vinyl benzyl chlorides with mono-, di-, or trifunctional hydroxy compounds), and the like.

The inventive composition may further contain other additives, such as defoaming agents, leveling agents, dyes, and pigments.

The inventive composition may be applied onto the substrate of choice, such as a wafer or die, such as by stencil printing, screen printing or spray coating, the inventive composition may then be dried if necessary to remove solvent, if present, or cooled to solidify the inventive composition. A typical drying time may be about 30 minutes at a temperature of about 100° C., though any temperature below the cure onset of the curable componenets of the inventive composition may be chosen. The length of time may vary depending on the time required for the surface of the inventive composition to become tack free at the chosen temperature.

Any time after the surface of the inventive composition is tack free (either by drying or cooling), die bonding may occur.

Conditions suitable for curing the inventive composition include subjecting the inventive compositions to a temperature of at least about 175° C. but less than about 300° C. for about 0.5 up to about 2 minutes. A typical die bonding setting is a time of about 10 seconds at a temperature of about 100° C. using 500 cN spread, in the case of a 7.6 mm×7.6 mm die. This rapid, short duration heating can be accomplished in a variety of ways, e.g., with in-line snap cure stations such as those manufactured by Nihon Sanso, a heated stage mounted on the diebonder, or an IR beam provided by an EFOS Novacure IR unit.

The die can be heated by pulsing heat through the die collet, which is an available feature in film diebonders, such as those manufactured by ESC. In the case of thin die which are typically warped due to the build-up of residual mechanical stress during the grinding process, heating the die above a certain temperature has the effect of annealing the die and reducing warpage.

In a further aspect of the invention, there are provided methods for adhesively attaching a device to a substrate comprising subjecting a sufficient quantity of an inventive composition positioned between a substrate and a device to conditions suitable to cure the inventive composition. Devices contemplated for use in the practice of the present invention include any surface mount component such as, for example, semiconductor die, resistors, capacitors, and the like.

Preferably, devices contemplated for use in the practice of invention methods are semiconductor dies. Substrates contemplated for use include metal substrates (e.g., lead frames), organic substrates (e.g., laminates, ball grid arrays, and polyamide films), and the like.

### EXAMPLES

Conductive, curable compositions were prepared from the noted constituents in the respective amounts in grams as set forth below in Tables 1a and 1b, from which 25 parts of the resin portion from Table 1a and 75 parts of the filler portion from Table 1b were mixed together components for Sample No. 1 for about 10 to 15 minutes at room temperature. And for Sample No. 2, 20 parts of the resin portion from Table 1a and 80 parts of the filler portion from Table 1b were mixed together for the same time period.

TABLE 1a

| Type | Identity | 1 | 2 |
|---|---|---|---|
| Maleimide | X-BMI¹ | 52.25 | 52.25 |
| (Meth)acrylate | Bisphenol A Diacrylate | 29.85 | 29.85 |
| | Dicyclopentadiene Acrylate | 8.9 | 8.9 |
| Comonomer | Maleated (Polybutadiene) | 5 | 5 |
| Coupling Agent | 3-methylmaleimido | 2 | 2 |
| | propyltrimethoxysilane | | |
| Free radical catalayst | Dicumyl peroxide | 2 | 2 |

¹X-BMI (the 1,20-bismaleimido derivative of 10,11-dioctyl-eicosane), was prepared according to the procedure set forth in U.S. Pat. No. 5,973,166, the disclosure of which is hereby expressly incorporated herein by reference.

TABLE 1b

| Type | Identity | 1 | 2 |
|---|---|---|---|
| Conductive filler | Silver | * | ** |
| Organometallic complex | SR-633 | 0.3 | — |

* an amount of silver was chosen to represent 75 wt %
** an amount of silver was chosen to represent 80 wt %

Sample No. 1 is within the scope of the invention, whereas Sample No. 2 is presented for comparative purposes.

An aliqout of each of the samples was placed on a substrate, a silicon die was then placed onto the aliquot, and the assembly was cured to a temperature of 185° C. for 30 minutes.

The samples were evaluated for electrical conductivity by dispensing each sample onto a glass slide, and curing the sample. Once cured, the cured sample is measured to determine its thickness, and then the cured sample is attached to an ohmmeter and its resistance in ohms is measured and recorded. Th volume resistiivity of each cured sample was then calculated. A lower volume resistivity indicates greater electrical conductivity, and is therefore desirable.

The volume resistivity of each cured sample are shown below in Table 2.

TABLE 2

| 1 | 2 |
|---|---|
| 0.000193 | 0.0014 |

Additional samples were prepared from the components listed below in Table 3a, from which 20 parts of the resin portion from Table 3a and 80 parts of the filler portion from Table 3b were mixed together components for about 10 to 15 minutes at room temperature.

TABLE 3a

| Type | Identity | 3 | 4 |
|---|---|---|---|
| Maleimide | X-BMI | 52.25 | 52.25 |
| (Meth)acrylate | Bisphenol A Diacrylate | 29.85 | 29.85 |
| | Dicyclopentadiene Acrylate | 8.9 | 8.9 |
| Comonomer | Maleated (Polybutadiene) | 5 | 5 |
| Coupling Agent | 3-methylmaleimido | 2 | 2 |
| | propyltrimethoxysilane | | |
| Free radical catalayst | Dicumyl peroxide | 2 | 2 |

TABLE 3b

| Type | Identity | 3 | 4 |
|---|---|---|---|
| Conductive filler | Silver | ** | ** |
| Organometallic complex | SR-633 | 0.3 | 0.3 |

** an amount of silver was chosen to represent 80 wt %

preparation, they were allowed to remain at ambient temperature conditions for at least 4 weeks before evaluating their performance. The results of their performance are set forth below in Table 4.

TABLE 4

| 3 | 4 |
|---|---|
| 0.00056 | 0.00037 |

The results from these samples indicate that while some 15, additional benefit from a conductivity standpoint was observed compared to the control Sample No. 2, that additional benefit was not as pronounced as in Sample No. 1 which was evaluted after its preparation. A conclusion one may thus draw is that the inventive compositions do not have sufficient shelf stability under ambient temperature conditions to provide reproducible results. Accordingly, one may wish to prepare samples of inventive compositions just prior to use, store them under reduced temperature conditions, agitate them vigourously prior to use, or any combination of these and other storage and handling techniques.

What is claimed is:

1. A conductive, curable composition for microelectronic assembly and packaging applications, comprising:
(a) a free radical polymerizable component comprising one or more of a maleimide-containing compound, itaconimide-containing compound, or a nadimide-containing compound;
(b) an organometallic complex selected from the group consisting of (meth)acrylate complexes of zinc, magnesium, sodium, potassium, calcium, barium, cobalt, copper, aluminum, iron and combinations thereof;
(c) a conductive filler; and
(d) a cure initiator, wherein cured products of the composition are capable of demonstrating about a two fold improvement in volume resistivity over compositions of component (a), (c) and (d) without component (b).

2. The composition according to claim 1, further comprising a (meth)acrylate-containing component.

3. The composition according to claim 1, wherein the organometallic complex is a calcium (meth)acrylate complex.

4. The composition according to claim 1, wherein the organometallic complex is a zinc (meth)acrylate complex.

5. The composition according to claim 1, wherein the maleimide-containing compound, the nadimide-containing compound, and the itaconimide-containing compound comprise a maleimide functional group, itaconimide functional group or nadimide functional group, respectively, attached to a monovalent radical or maleimide functional groups, itaconimide functional groups or nadimide functional groups, respectively, separated by a polyvalent radical, each of the monovalent radical or the polyvalent radical having sufficient length and branching to render the maleimide-containing compound, the itaconimide-containing compound or the nadimide-containing compound, respectively, a liquid.

6. The composition according to claim 1, wherein the maleimide-containing compound, the nadimide-containing compound, and the itaconimide-containing compound comprise the structures I, II, and III, respectively 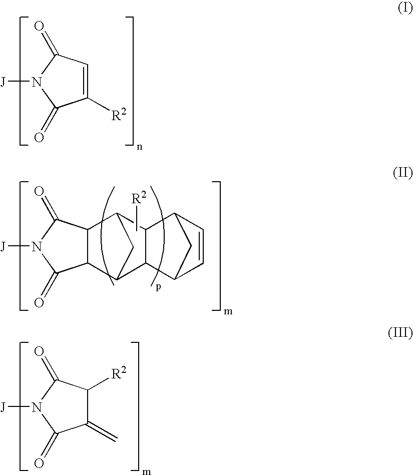
wherein:
m=1-6,
p 0-6,
each R² is independently hydrogen, alkyl or substituted alkyl, and
J is a member selected from the group consisting of
(a) saturated straight chain alkyl or branched chain alkyl, optionally containing optionally substituted aryl moieties as substituents on the alkyl chain or as part of the backbone of the alkyl chain, and wherein the alkyl chains have up to about 20 carbon atoms;
(b) a siloxane having the structure: —(C(R³)₂)_{d}—[Si(R⁴)₂—O]_{f}—Si(R⁴)₂—(C(R³)₂)ₑ—, —(C(R³)₂)_{d}—C(R³)—C(O)O—(C(R³)₂)_{d}—[Si(R⁴)₂—O]_{f}—Si(R⁴)₂—(C(R³)₂)ₑ—O(O)C—(C(R³)₂)ₑ—, or —(C(R³)₂)_{d}—C(R³)—O(O)C—(C(R³)₂)_{d}—[Si(R⁴)₂—O]_{f}—Si(R⁴)₂—(C(R³)₂)ₑ—C(O)O—(C(R³)₂)ₑ—
wherein:
each R³ is independently hydrogen, alkyl or substituted alkyl,
each R⁴ is independently hydrogen, lower alkyl or aryl,
d=1-10,
e=1-10, and
f=1-50;
(c) a polyalkylene oxide having the structure:
[(CR₂)ᵣ—O—]_{f}—(CR₂)ₛ—
wherein:
each R is independently hydrogen, alkyl or substituted alkyl,
r=1-10,
s=1-10, and
f is as defined above;
(d) aromatic groups having the structure: 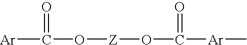
wherein:
each Ar is a monosubstituted, disubstituted or trisubstituted aromatic or heteroaromatic ring having in the range of 3 up to 10 carbon atoms, and
Z is:
(i) saturated straight chain alkylene or branched chain alkylene, optionally containing saturated cyclic moieties as substituents on the alkylene chain or as part of the backbone of the alkylene chain, or
(ii) polyalkylene oxides having the structure:
—[(CR₂)ᵣ—O—]_{q}—(CR₂)ₛ—
wherein:
each R is independently hydrogen, alkyl or substituted alkyl, and r and s are each defined as above, and
q falls in the range of 1 up to 50;
(e) di- or tri-substituted aromatic moieties having the structure: 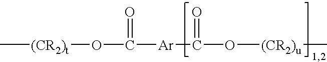
wherein:
each R is independently hydrogen, alkyl or substituted alkyl,
t falls in the range of 2 up to 10,
u falls in the range of 2 up to 10, and
Ar is as defined above;
(f) aromatic groups having the structure: 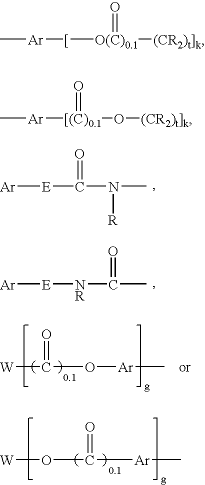
wherein:
each R is independently hydrogen, alkyl or substituted alkyl,
t=2-10,
k=1, 2 or 3,
g=1 up to about 50,
each Ar is as defined above,
E is —O— or —NR⁵—, wherein R⁵ is hydrogen or lower alkyl; and
W is
(i) straight or branched chain alkyl, alkylene, oxyalkylene, alkenyl, alkenylene, oxyalkenylene, ester, or polyester,
(ii) a siloxane having the structure —(C(R³)₂)_{d}—[Si(R⁴)₂—O]_{f}—Si(R⁴)₂—(C(R³)₂)ₑ—, —(C(R³)₂)_{d}—C(R³)—C(O)O—(C(R³) 2)_{d}—[Si(R⁴)₂—O]_{f}—Si(R⁴)₂—(C(R³)₂)ₑ—O(O)C—(C(R³)₂)ₑ—, or —(C(R³)₂)_{d}—C(R³)—O(O)C—(C(R³)₂)_{d}—[Si(R⁴)₂—O]_{f}—Si(R⁴)₂—(C(R³)₂)ₑ—C(O)O—C(R³)₂)ₑ—, wherein:
each R³ is independently hydrogen, alkyl or substituted alkyl,
each R⁴ is independently hydrogen, lower alkyl or aryl,
d=1-10,
e=1-10, and
f=1-50; or
(iii) a polyalkylene oxide having the structure:
—[(CR₂)ᵣ—O—]_{f}—(CR₂)ₛ—
wherein:
each R is independently hydrogen, alkyl or substituted alkyl,
r=1-10,
s=1-10, and
f is as defined above;
optionally containing substituents selected from hydroxy, alkoxy, carboxy, nitrile, cycloalkyl or cycloalkenyl;
(g) a urethane group having the structure:
R⁷—U—C(O)—NR⁶—R⁸—NR⁶—C(O)— (O—R⁸—O—C(O)—NR⁶—R⁸—NR⁶—C(O))ᵥ—U—R⁸—
wherein:
each R⁶ is independently hydrogen or lower alkyl;
each R⁷ is independently an alkyl, aryl, or arylalkyl group having 1 to 18 carbon atoms;
each R⁸ is an alkyl or alkyloxy chain having up to about 100 atoms in the chain, optionally substituted with Ar;
U is —O—, —S—, —N(R)—, or —P(L)_{1,2}-,
wherein R as defined above, and wherein each L is independently ═O, ═S, —OR or —R; and
v=0-50;
(h) polycyclic alkenyl; and combinations thereof.

7. The composition according to claim 6, wherein m=1-6, p=0, each R² is independently selected from hydrogen or lower alkyl, and J is a monovalent or polyvalent radical selected from the group consisting of hydrocarbyl, substituted hydrocarbyl, heteroatom-containing hydrocarbyl, substituted heteroatom-containing hydrocarbyl, hydrocarbylene, substituted hydrocarbylene, heteroatom-containing hydrocarbylene, substituted heteroatom-containing hydrocarbylene, polysiloxane, polysiloxane-polyurethane block copolymer, and combinations of two or more thereof, optionally containing one or more linkers selected from the group consisting of a covalent bond, —O—, —S—, —NR—, —O—C(O)—, —O—C(O)—O—, —O—C(O)—NR—, —NR—C(O)—, —NR—C(O)—O—, —NR—C(O)—NR—, —S—C(O)—, —S—C(O)—O—, —S—C(O)—NR—, —S(O)—, —S(O)₂—, —O—S(O)₂—, —O—S(O)₂—O—, —O—S(O)₂—NR—, —O—S(O)—, —O—S(O)—O—, —O—S(O)—NR—, —O—NR—C(O)—, —O—NR—C(O)—O—, —O—NR—C(O)—NR—, —NR—O—C(O)—, —NR—O—C(O)—O—, —NR—O—C(O)—NR—, —O—NR—C(S)—, —O—NR—C(S)—O—, —O—NR—C(S)—NR—, —NR—O—C(S)—, —NR—O—C(S)—O—, —NR—O—C(S)—NR—, —O—C(S)—, —O—C(S)—O—, —O—C(S)—NR—, —NR—C(S)—, —NR—C(S)—O—, —NR—C(S)—NR—, —S—S(O)₂—, —S—S(O) 2—, —S—S(O)₂—NR—, —NR—O—S(O)—, —NR—O—S(O)—O—, —NR—O—S(O)—NR—, —NR—O—S(O)₂—, —NR—O—S(O)₂—O—, —NR—O—S(O)₂—NR—, —O—NR—S(O)—, —O—NR—S(O)—O—, —O—NR—S(O)—NR—, —O—NR—S(O)₂—O—, —O—NR—S(O)₂—NR—, —O—NR—S(O)₂—, —O—P(O)R₂—, —S—P(O)R₂—, —NR—P(O)R₂—, wherein each R is independently hydrogen, alkyl or substituted alkyl, and combinations of any two or more thereof.

8. The composition according to claim 6, wherein the maleimide-containing compound, the nadimide-containing compound, and the itaconimide-containing compound comprises a maleimide functional group, nadimide functional group or itaconimide functional group, respectively, attached to a monovalent radical or maleimide functional groups, nadimide functional groups or itaconimide functional groups, respectively, separated by a polyvalent radical, each of the monovalent radical or the polyvalent radical having sufficient length and branching to render the maleimide-containing compound, the nadimide-containing compound, or the itaconimide-containing compound, respectively, a liquid.

9. The composition according to claim 1, wherein the conductive filler is thermally conductive.

10. The composition according to claim 1, wherein the conductive filler is electrically conductive.

11. A method for adhesively attaching a chip die to a circuit board, said method comprising:
(a) applying the composition of claim 1 to said chip die,
(b) adjoining said chip die with said circuit board to form an assembly wherein said chip die and said circuit board are separated by the composition applied in step (a), and
(c) subjecting said assembly formed in step (b) to conditions suitable to cure said composition.

12. A method of improving conductivity in curable compositions for microelectronic assembly and packaging applications, comprising:
(a) providing a free radical polymerizable component comprising one or more of a maleimide-containing compound, itaconimide-containing compound, or a nadimide-containing compound, and a cure initiator;
(b) providing an organometallic complex selected from the group consisting of (meth)acrylate complexes of zinc, magnesium, sodium, potassium, calcium, barium, cobalt, copper, aluminum, iron and combinations thereof;
(c) providing a conductive filler; and
(d) mixing the provided components in steps (a)-(c) to form a conductive, curable composition, whereby cured products of the composition are capable of demonstrating about a two fold improvement in volume resistivity over compositions of the components in steps (a) and (c) without the component in step (b).

13. The composition according to claim 1, wherein the cure initiator is a radical heat cure catalyst.

14. The composition according to claim 1, wherein the cure initiator is a radical photocure catalyst.

15. An article of manufacture comprising a semiconductor chip attached to and in electrical interconnection with a carrier substrate, the semiconductor chip having a first surface and a second surface, with the first surface having electrical contacts arranged in a predetermined pattern thereon for providing electrical engagement with the carrier substrate, and with the second surface having a cured composition of claim 1 disposed on a layer or a portion thereof, so as to provide attachment between the semiconductor chip and the carrier substrate.

16. Reaction products of the composition according to claim 1.
